(19) United States
(12) Patent Application Publication
(10) Pub. No.: US 2011/0147631 A1
(43) Pub. Date: Jun. 23, 2011

(54) Air flow damper

(76) Inventor: Cherif Menassa, Kirkland (CA)

(21) Appl. No.: 12/926,971

(22) Filed: Dec. 21, 2010

Related U.S. Application Data
(60) Provisional application No. 61/282,130, filed on Dec. 22, 2009.

(51) Int. Cl. F16K 1/36; F01L 3/10

(52) U.S. Cl. 251/205; 251/337

(57) ABSTRACT

An air flow damper is formed of a multi-apertured flexible sheet sandwiched between two multi-apertured rigid plates, the sheet being slidable between the rigid plates and movable from an open configuration to a closed configuration in which latter the apertures of the rigid plates are sealably closed by the flexible sheet.

### CROSS REFERENCE TO RELATED APPLICATION

Benefit of U.S. Provisional Application for Patent Ser. No. 61/282,130 filed on Dec. 22, 2009, which is incorporated herein by reference, is hereby claimed.

### FIELD OF THE INVENTION

The present invention relates to an air damper apparatus, and is more particularly concerned with an air flow damper.

### BACKGROUND OF THE INVENTION

It is well known in the art to use air flow dampers in to regulate the flow of air through or into a space, for example through an air duct into a neighbouring space, e.g. a room or refrigerator. For example, U.S. Pat. No. 7,152,419, issued to Armour et al., and U.S. Pat. No. 4,879,878, issued to Polkinghorne, teach conventional air flow dampers which include at least one rigid fixed plate and a rigid movable plate, the fixed plate and movable plate both having perforations or apertures spaced apart one another by intermediate portions extending therebetween. The movable plate is typically movable relative to the fixed plate between closed and open configurations for the damper in which the respective intermediate portions thereof cover, respectively, more or less of the respective apertures of the fixed plate and vice-versa. Thus, in the open configuration, the amount of air which may circulate through the apertures, and the damper, is greater than in the closed configuration, in which the apertures are preferably completely covered. Unfortunately, for such conventional dampers, due to the rigid nature of the plates, a small amount of air is able to pass therebetween, even when the dampers are in a closed configuration in which the apertures are preferably completely covered.

Accordingly, there is a need for an improved air flow damper.

### SUMMARY OF THE INVENTION

It is therefore a general object of the present invention to provide an improved an improved air flow damper.

An advantage of the present invention is that the air flow damper provided thereby offers increased blockage or dampening of air flow.

Another advantage of the present invention is that the air flow damper provides the increased dampening regardless of the direction of the flow of air.

In one aspect, the present invention provides an air flow damper comprising:
first and second rigid plates having a plurality of plate apertures and a plurality of plate spacer portions separating the plate apertures, the rigid plates being rigidly connected to one another with the plate apertures and plate spacer portions on each plate aligned with one another; and
a flexible sheet extending proximally adjacent and between the rigid plates and having a plurality of sheet apertures and a plurality of sheet spacer portions, the sheet being movable between an open configuration, in which sheet apertures and plate apertures are aligned to enable flow of air, and a closed configuration in which the sheet spacer portions close the plate apertures, the sheet spacer portions being in use movable by the flow of air into at least partially sealing abutment with the plate spacer portions and partially through the plate apertures to provide at least partial sealing of the plate apertures by the sheet spacer portions thereby to dampen the flow of air.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a front perspective view of an embodiment of an air flow damper in accordance with the present invention;

FIG. 1a is an exploded view of the air flow damper shown in FIG. 1;

FIG. 2 is a side sectional view of the air damper, taken along line 2-2 of FIG. 1 in a closed configuration therefor;

FIG. 2a is a side sectional view of the air damper, taken along line 2-2 of FIG. 1 in an open configuration therefor;

FIG. 3 is a side sectional view of the air damper, taken along line 3-3 of FIG. 1 in a closed configuration therefor;

FIG. 3a is a side sectional view of the air damper, taken along line 3-3 of FIG. 1 in an open configuration therefor;

FIG. 4 is a partial enlarged view of a top bracket of the air flow damper shown in FIG. 1; and

FIG. 5 is a top sectional view of the of the air flow damper, taken along line 5-5 of FIG. 1.

### DETAILED DESCRIPTION OF THE PREFERRED EMBODIMENTS

With reference to the annexed drawings the preferred embodiments of the present invention will be herein described for indicative purpose and by no means as of limitation.

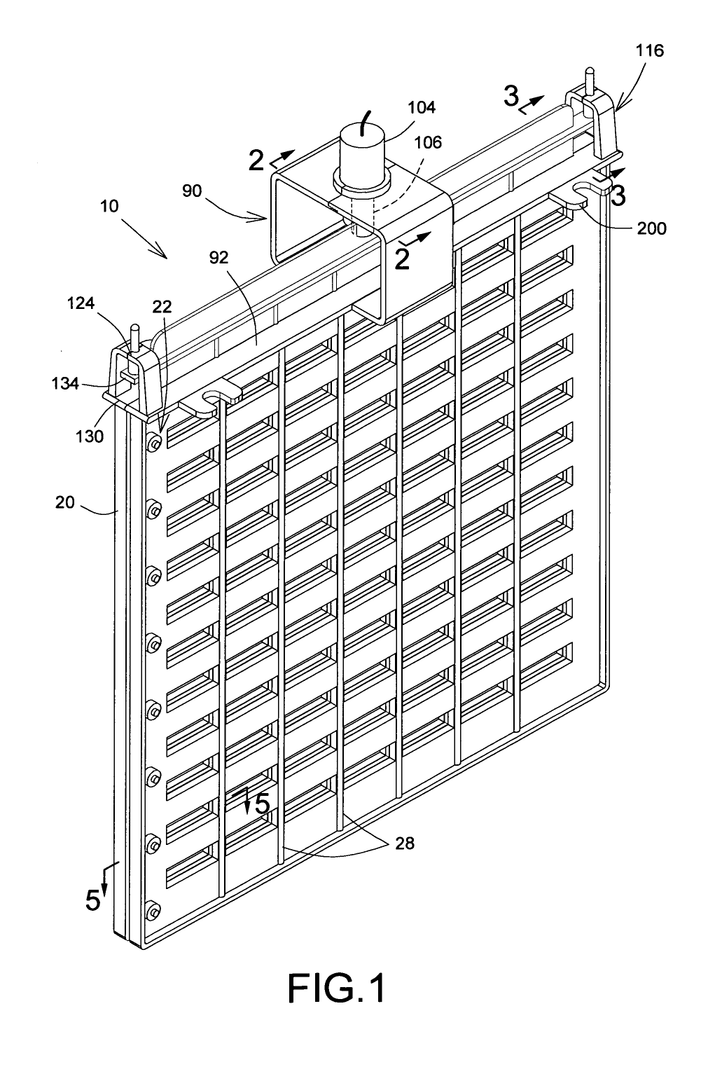

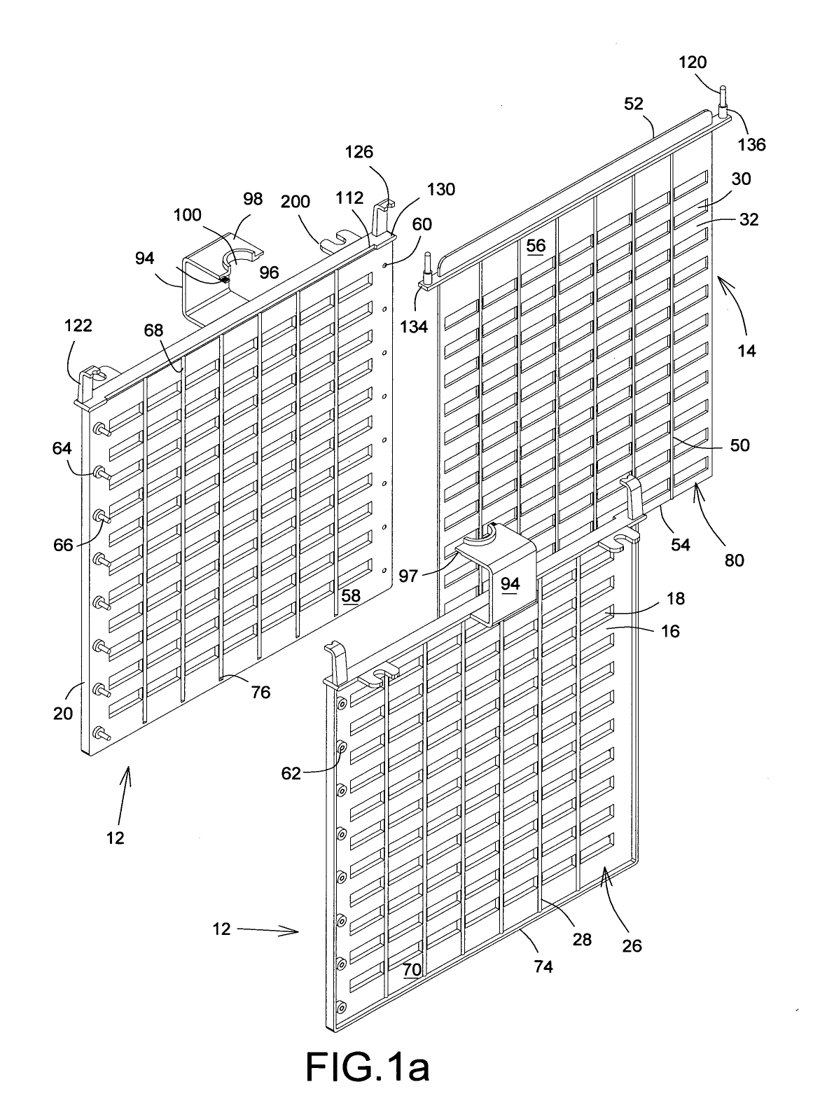

Referring to FIGS. 1 and 1a, there is shown a front perspective view of an air flow damper, shown generally as 10, in accordance with the present invention. As shown, the damper 10 includes first and second rigid plates, generally 12, connected slightly spaced apart one from the other. An inner plate or sheet, shown generally as 14, is movably, and preferably slidably, mounted between the plates 12. The plates 12, preferably identical, may be made of a rigid metal or plastic or the like. The sheet 14, in contrast, is primarily constructed of a resilient and flexible material, such as a resilient and flexible plastic, but may have a plurality of at least partially rigid guide beams or ridges 50 extending from sheet retainer plate 132, proximal sheet top 52, to sheet bottom 54. The guide ridges 50 are preferably parallel one another and protrude from both sheet faces 56 of the sheet 14.

The plates 12 are connected slightly spaced apart from one another by valve bracket, shown generally as 90, and by spacing connectors, shown generally as 22. The spacing connectors 22 are spaced apart and connect the plates 12 adjacent and along side walls 20 thereof. For example, the spacing connectors 22 may include spacing bolts 66 extending from inner plate face 58 of each plate 12 through bolt holes 60 of the other plate 12 and fixedly engaged in nuts or sockets 62 on the outer plate face 70 of the other plate 12 to connect the plates 12. Each spacing bolt 66 has a spacing ring 64 against which the inner plate faces 58 of each plate 12 abut when connected to space the plates 12 apart from one another.

Spacing apart of plates 12 is further ensured by upper plate wall 92 of each plate 12, which extends across the top of plate 12 on both faces 58, 70 between plate side walls 20. Specifically, the upper plate walls 92 are sized, shaped, and positioned to abut one another proximal side walls 20 over plate inner face 58 when the plates 12 are connected to one another by spacing connectors 22 and valve bracket 90. An inner slot indentation 112 in each upper plate wall 92 forms a sheet slot 114 for sheet 14 between upper plate walls 92 when the plates 12 are connected. Similarly, first and second side brackets, shown generally as 116, for receiving sheet mounting rods 120 are positioned on opposite ends 130 of the upper plate wall 92 proximal side wall 20. Each side bracket 116 is formed from first and second side bracket halves 122, one on each plate 12, sized, shaped, and positioned such that when the plates 12 are connected to one another by spacing connectors 22 and valve bracket 90, the side bracket halves 122 form side brackets 116. The rod aperture indentations 126 of the halves 122 form a rod aperture 124 for each side bracket 116 through which rod 120 extends.

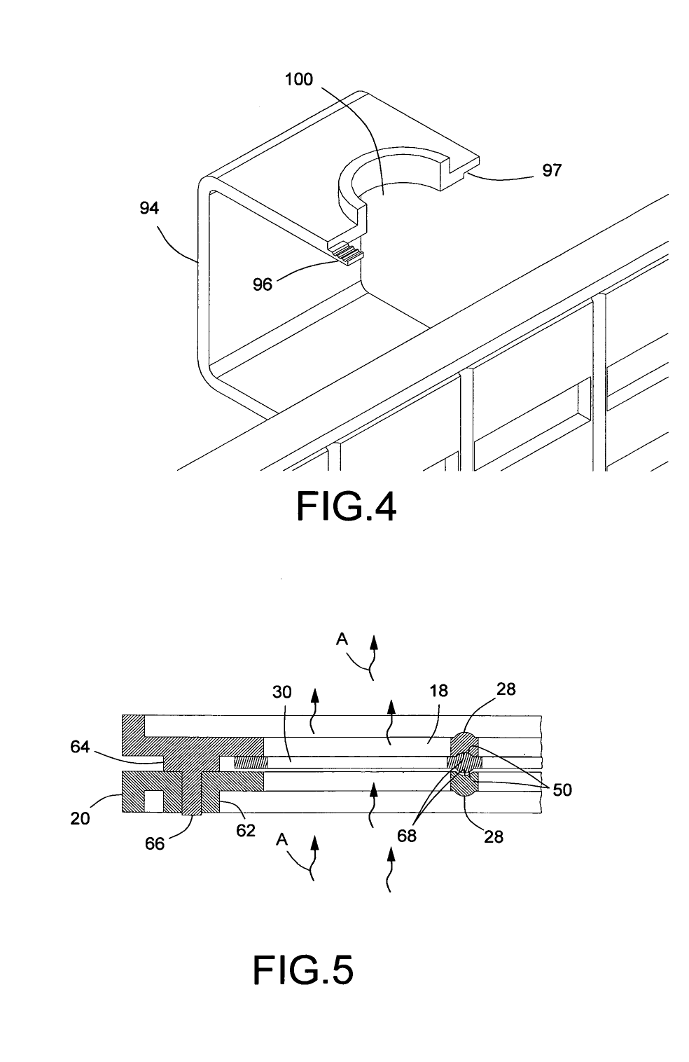

Reference is now made to FIGS. 1, 1a, and 4. The valve bracket 90 is fixedly connected to each plate 12 along upper plate wall 92. Each plate 12 has a respective valve bracket half 94 connectable to the other bracket half 94, by interlocking of outwardly protruding teeth 96 with inwardly recessed teeth 97 on top valve bracket plate 98 of each half 94, to form the valve bracket 90. Each top valve bracket plate 98 has a, preferably semicircular, mounting indentation 100, which together form a, preferably circular, valve aperture 102 when the bracket halves 94 and plates 12 are connected and in which a solenoid valve 104 is mounted.

The sheet 14 is connected at top sheet end 52 to plunger 106 of solenoid valve 104, and is thereby movably mounted between plates 12. Further, the sheet 14 is fixedly seated or held, proximal the top sheet end 52, in a sheet retainer plate 132. The sheet retainer plate 132 has sheet mounting rods 120 on opposing plate ends 134 thereof, each having an enlarged rod stopper 136 adjacent the retainer plate 132. The sheet mounting rods 120 are positioned on the retainer plate 132, and the side brackets 116 on the upper plate wall 92, for slidable movable extension of the rods 120 in the rod mounting, or aperture, 124 of bracket 116 with sheet 14 extending through sheet slot 114 and the retainer plate 132 being disposed between the upper plate wall 92 and the upper side bracket wall 138 having rod apertures 124. Accordingly, the retainer plate 132, and notably sheet mounting rods 120 are movable back and forth in side brackets 116 through rod apertures 124 as sheet 14 is moved. The rod stopper 136, however, is sized and shaped such that it may not pass through rod aperture 124 and thus limits movement of sheet 14. Biasing means 140, for example springs 140 through which rods 120 extend and which are connected to upper side bracket wall 138 and retainer plate 132 bias rods 120, retainer plate 132 and sheet 14 upwardly away from upper plate wall 92.

Each rigid plate 12 has a plurality of spaced apart respective plate apertures 18 and a plurality of spaced apart respective plate spacer portions 16, both plates 12 preferably having an identical number of spacer portions 16 and an identical number of, preferably identically sized and shaped, apertures 18. As shown, the plate apertures 18 and spacer portions 16 are preferably rectangular in shape. On each plate 12, each plate aperture 18 is separated, i.e. spaced apart, from any adjacent plate aperture 18 by an adjacent plate spacer portion 16 of the plate 12, the spacer portions 16 being preferably greater in height than height of the plate apertures 18. Thus, the plate apertures 18 are longitudinally spaced apart from one another by spacer portions 16, the alternating apertures 18 and plate spacer portions 16 extending longitudinally between the upper plate wall 92 and plate bottom wall 74. As shown, the plate apertures 18 and spacer portions 16 are preferably rectangular in shape, although other shapes may be envisaged.

Reference is now made to FIGS. 1, 1a, and 5. Each rigid plate 12 also has, preferably, a plurality of plate columns or groups 26 of alternating plate apertures 18 and plate spacer portions 16, again extending between upper plate wall 92 and plate bottom wall 74, separated by a plurality of spaced apart guide slots 68 formed in the inner plate face 58. Again, the rigid plates 12 preferably have an identical quantity of plate groups 26 and guide slots 68, with each grouping 26 separated by an intermediate guide slot 68, one guide slot 68 for each guide ridge 50. Each guide slot 68 extends from the plate top 72 to a bottom slot end 76 proximal the plate bottom 74. The guide slots 68 are spaced apart from one another at the same distance as the guide ridges 50 of sheet 14, and are sized and shaped for receiving guide ridges 50 of sheet 14, with the guide ridge 50 being slidably movable therein. Thus, the sheet 14 is movable back and forth in the sheet slot 114 by solenoid valve 104 and springs 140, with guide ridges 50 in guide slots 68, as best shown in FIG. 5. Optionally, but preferably, the guide slots 68, indented into inner face 58, form corresponding outer ridges 28 on the outer plate face 70.

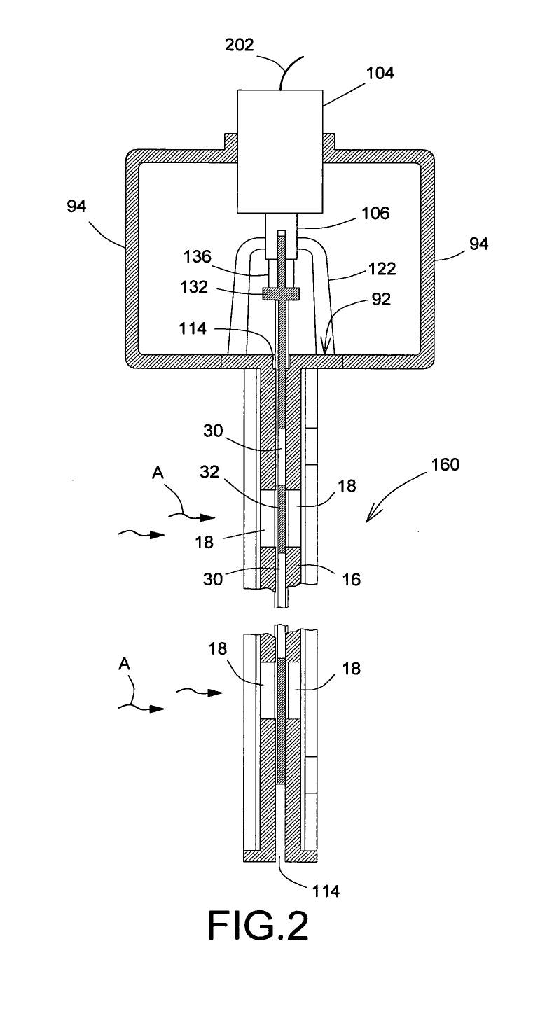

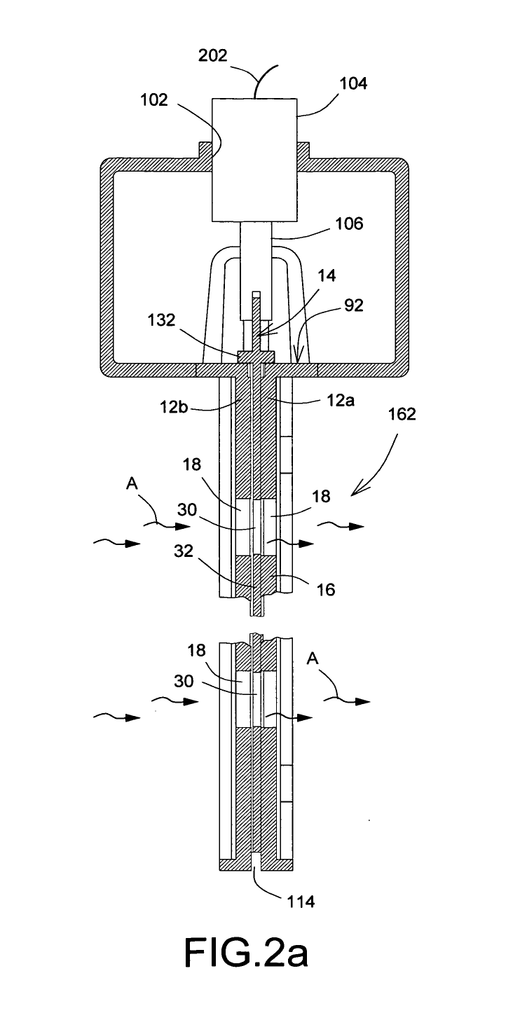

Reference is now made to FIGS. 1, 2, 2a, 3 and 3a. As shown, the rigid plates 12 are connected such that the plate groupings 26, plate apertures 18, and plate spacer portions 16 of each plate 12 are aligned with one another such that, but for the presence of sheet 14, the plate apertures 18 provide generally unobstructed passage through damper 10. In other words, the plate apertures 18 and spacer portions 16 are sized, shaped and positioned such that each plate aperture 18 and spacer portion 16 of one plate 12 are generally aligned with, respectively, a corresponding plate aperture 18 and spacer portion 16 on the other plate 12.

Similar to the rigid plates 12, the sheet 14 has a plurality of spaced apart sheet apertures 30 separated by sheet spacer portions 32 and which are similar in shape to, respectively, plate apertures 18 and plate spacer portions 16, and which extend in sheet groupings 80 between retainer plate 132 and sheet bottom 54, separated by guide ridges 50. While alternative shapes may be envisaged, sheet apertures 30 and sheet spacer portions 32 are also preferably rectangular in shape. Preferably, the number of sheet groupings 80 is identical to the number of plate groups 26, with each sheet aperture 30 and sheet spacer portion 32 of each sheet group 80 corresponding to aligned pairs of plate apertures 18 and plate spacer portions 16. The sheet apertures 30 are of similar size to plate apertures 18, but perhaps slightly smaller in their respective height compared to sheet aperture height. However, the sheet spacer portions 32 are larger than plate apertures 18 and sheet apertures 30, notably of greater height.

The sheet 14 is movable in sheet slot 114, with guide ridges 50 sliding in guide slots 68, towards plate bottom walls 74 from a default closed configuration, shown as 160, into an open position or configuration, generally 162, by extension of plunger 106 through actuation of valve 104. As will be appreciated by one skilled in the art, the solenoid valve 104 is typically actuated by application of electrical current. When the solenoid valve 104 is deactuated, by cutting flow of electrical current thereto, the sheet 14, plunger 106, and retaining plate 132 are biased by springs 140 away from plate bottom walls 74 back into closed position or configuration 160.

In the open configuration, the plunger 106 is extended, thus extending or expanding springs 140, and the sheet apertures 30 are aligned with, i.e. extend across, the plate apertures 18, thus enabling flow of air A through apertures 14, and damper 10. In open configuration 162, the sheet spacer portions 32 are aligned with plate spacer portions 16, possible extending slightly into plate apertures 18. Further, in open configuration 162, the guide ridges 50 are preferably seated abutting bottom slot end 76 and the sheet retainer plate 132 abuts the upper plate wall 92 across sheet slot 114.

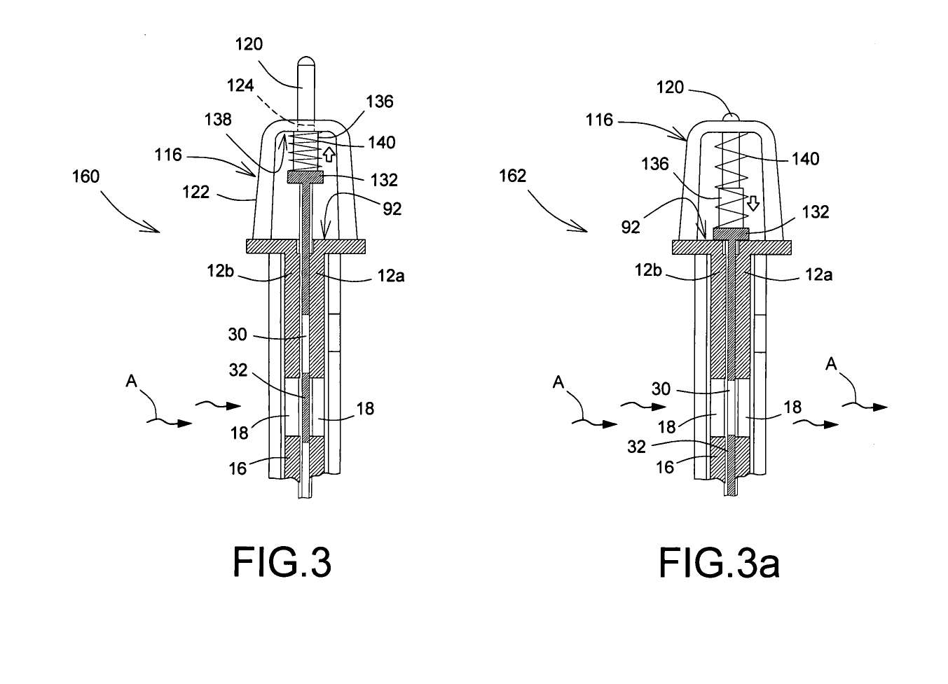

When the solenoid valve 104 is deactuated, the springs 140 resiliently contract upwardly away from upper plate wall 92, thus pulling the retaining plate 132 and sheet upwardly away from plate bottom wall 74 into the closed configuration 160, where the sheet spacer portions 32 are aligned with and overlay respective corresponding pairs of plate apertures 18 therefor. As the sheet spacer portions 32 are larger than the plate apertures 18, the sheet spacer portions 32 extend completely to cover the plate apertures 18 and partially over adjacent plate spacer portions 16 in closed configuration 160, thus dampening the air flow. Advantageously, due to flexible nature of sheet spacer portions 32, the air flow pushes the sheet spacer portions 32 in a direction A of air flow into at least partially sealing abutment with the adjacent plate spacer portions 16 of the plate 12a positioned furthermost in direction A, thus providing at least partial sealing of plate apertures 18 of the plate 12a positioned furthermost in direction A. This partial sealing provides additional air flow dampening. Obviously, should the direction A of air flow be reversed, the air flow would push the sheet spacer portions 32 into at least partially sealing abutment with the adjacent plate spacer portions 16 of the other plate 12b. As shown in FIG. 3, rod stopper 136 is sized, shaped, and positioned such that, when sheet 14 is in closed configuration, rod stopper 136 abuts against upper side bracket wall 138, thus preventing further movement of sheet 14 by springs 140.

It should be noted that that the positioning of sheet 14 and orientation of the spacer portions 16, 32, apertures 18, 30, springs 140, and solenoid valve 104 could be rearranged such that the open configuration 162 would be the default, maintained by springs 140, and that the closed configuration would require extension of plunger 106. Further, one skilled in the art will appreciate that the structure of the damper affords a rather simple assembly and construction. In brief, the plates 12 and sheets are manufactured separately. The plates 12 are then fastened to one another, with connectors 22 and bracket teeth 96 as described above, with sheet 14 engaged in sheet slot 114 and springs 140 placed in side brackets 116. Conventional air flow damper fasteners 200 are used to attach damper 10 to a duct, conduit or the liked, and wire 202 provides connection to a source of electrical current to operate solenoid valve. Alternatively, a damper slot could be formed in a side of the duct and through which the damper 10 could be slidably inserted and removed, possibly with a clipping or snapping mechanism to hold the damper 10 in place, thus allowing easy removal and reattachment of the damper 10 for washing of the damper 10. Such clipping mechanism could include a damper plate connected to the side of the duct, for example with screws, and having a plate slot aligned with the duct slot, the damper being snappably or clippingly retained and releasable on damper plate when slidably inserted and removed through damper and plate slots.

Although the present damper has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. An air flow damper, comprising:
first and second rigid plates having a plurality of plate apertures and a plurality of plate spacer portions separating the plate apertures, the rigid plates being rigidly connected to one another with the plate apertures and plate spacer portions on each plate aligned with one another; and
a flexible sheet extending proximally adjacent and between the rigid plates and having a plurality of sheet apertures and a plurality of sheet spacer portions, the sheet being movable between an open configuration, in which sheet apertures and plate apertures are aligned to enable flow of air, and a closed configuration in which the sheet spacer portions close the plate apertures, the sheet spacer portions being in use movable by the flow of air into at least partially sealing abutment with the plate spacer portions and partially through the plate apertures to provide at least partial sealing of the plate apertures by the sheet spacer portions thereby to dampen the flow of air.

2. An air flow damper according to claim 1 wherein the sheet spacer portions are of greater dimension than the plate apertures whereby in the closed configuration the sheet spacer portions overlap and close off the plate apertures.

3. An air flow damper according to claim 1 wherein the flexible sheet is biased into one configuration.

4. An air flow damper according to claim 3 wherein the flexible sheet is biased into the closed configuration.

5. An air flow damper according to claim 3 wherein the flexible sheet is biased into the open configuration.

6. An air flow damper according to claim 3 wherein the flexible sheet is biased into one configuration through the agency of at least one spring.

7. An air flow damper according to claim 1 wherein the flexible sheet is movable from one configuration to another by means of an actuator operable between the rigid plates and the flexible sheet, and a mounting is provided on the rigid plates for the actuator.

8. An air flow damper according to claim 7 wherein the actuator is in the form of a solenoid provided with a plunger acting on the flexible sheet, and the mounting is in the form of a bridge extending over the flexible sheet.

9. An air flow damper according to claim 8 wherein the degree of movement of the flexible sheet is limited.

10. An air flow damper according to claim 9 wherein the limitation of the movement of the flexible sheet is provided by at least one stop as between the flexible sheet and the rigid plates.

11. An air flow damper according to claim 10 wherein the flexible sheet is reciprocally slidable between the first and second rigid plates.

12. An air flow damper according to claim 11 wherein the flexible sheet is provided with a sheet retainer plate at each end thereof and guide means extend between the retainer plates.

13. An air flow damper according to claim 12 wherein the guide means are in the form of elongate ridges which protrude from both faces of the flexible sheet for sliding engagement within guide slots provided on the rigid plates.

14. An air flow damper according to claim 8 wherein the flexible sheet is sandwiched between the rigid plates, the rigid plates being connected together and the bridge extending over the flexible sheet at one end thereof.

15. An air flow damper according to claim 14 wherein the rigid plates interlock one with the other.

16. An air flow damper according to claim 15 wherein the plate apertures on one of the rigid plates align substantially with corresponding plate apertures on the other plate.
